(19) United States
(12) Patent Application Publication
(10) Pub. No.: US 2013/0102802 A1
(43) Pub. Date: Apr. 25, 2013

(54) Method of Lipid Extraction

(71) Applicant: Utah State University, North Logan, UT (US)

(72) Inventors: Ashik Sathish, North Logan, UT (US); Ronald Sims, Logan, UT (US)

(73) Assignee: Utah State University, North Logan, UT (US)

(21) Appl. No.: 13/660,161

(22) Filed: Oct. 25, 2012

Related U.S. Application Data
(60) Provisional application No. 61/551,049, filed on Oct. 25, 2011.

(51) Int. Cl. C11B 1/10

(52) U.S. Cl. CPC C11B 1/10
USPC 554/19; 554/8

(57) ABSTRACT

A method of extracting lipids from wet algae, the method includes hydrolyzing a slurry comprising algae and water by adding an acidic hydrolyzing agent to yield an acidic slurry, hydrolyzing the acidic slurry by adding a basic hydrolyzing agent to yield a basic slurry, separating a liquid phase from biomass in the basic slurry, forming a precipitate within the liquid phase, and separating free fatty acids from the precipitated solid phase with the advantage of removed or reduced chlorophyll contamination of the algal lipids.

### CROSS-REFERENCE TO RELATED APPLICATIONS

This application claims priority to U.S. Provisional Patent Application No. 61/551,049, filed Oct. 25, 2011, the entirety of which is herein incorporated by reference.

### GOVERNMENT SPONSORED RESEARCH

This invention was made, at least in part, with government support under contract DE-EE0003114 awarded by the United States Department of Energy. The government has certain rights in the invention.

### TECHNICAL FIELD

The present disclosure relates to lipid extraction, more specifically, to lipid extraction from algal biomass for biodiesel production.

### BACKGROUND

The production of biodiesel from various biological feedstocks, such as vegetable oil, animal fats, halophytes, and algae has been explored in an effort to enable alternative fuel sources. Extraction of the oil from biological feedstocks may be undertaken by various conventional methods depending on the feedstock. However, improved methods for extracting the oil from algae are needed for commercial viability and/or feasibility to be established.

### SUMMARY

Typically, algae as a biodiesel feedstock is dried prior to processing. However the energy costs of harvesting and then drying algae from, for example, waste ponds, are substantial. What's more, a drying step is time intensive. The processes described herein allow for lipid extraction from algal biomass in wet form, which can significantly reduce the overall production costs of biodiesel from algae. This method also eliminates or drastically reduces the pigments carried through by conventional processes, which can taint the end product biodiesel if purification steps are not taken. For example, the presence of chlorophyll and other pigments requires purification steps to generate useable biodiesel; generally vacuum distillation. Such additional costly steps may be avoided if the pigments are reduced prior to biodiesel production.

The present disclosure in aspects and embodiments addresses these various needs and problems by providing methods for extracting lipids from algae, which may include hydrolyzing a slurry comprising algae and water by adding an acidic hydrolyzing agent to yield an acidic slurry, hydrolyzing the acidic slurry by adding an excess of a basic hydrolyzing agent to yield a basic slurry, separating a liquid phase from biomass in the basic slurry, forming a precipitate within the liquid phase, and separating free fatty acids from the formed precipitate.

### BRIEF DESCRIPTION OF THE DRAWINGS

FIG. 1 illustrates an exemplary method of lipid extraction.

FIG. 2 illustrates the precipitation of algal pigments that occurs using an exemplary method.

FIG. 3 illustrates the reduction of pigment contamination of crude biodiesel as a result of the precipitation of chlorophyll prior to the conversion of algal lipids to biodiesel.

### DETAILED DESCRIPTION

The present disclosure covers methods, compositions, reagents, and kits for an improved method of lipid extraction from algal biomass. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

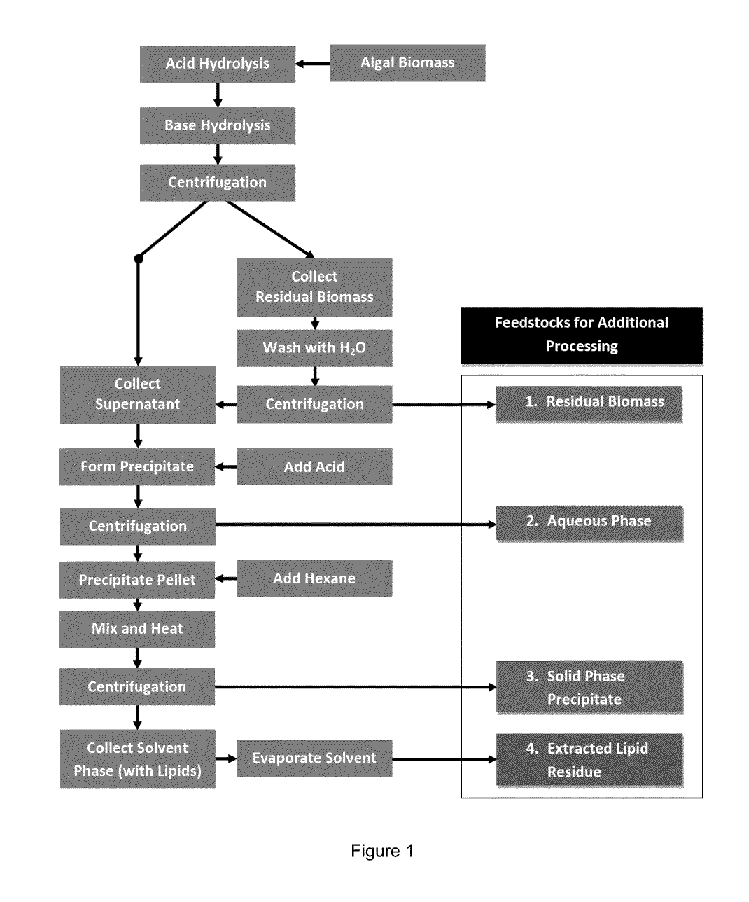

In some embodiments, the methods may include the following steps: (1) acid hydrolysis, (2) base hydrolysis, (3) biomass and liquid phase separation, (4) precipitate formation, (5) free fatty acid extraction, and optionally (6) biodiesel production. FIG. 1 illustrates a flow diagram of an exemplary method.

Feedstock

As a feedstock, any suitable algae, cyanobacteria, or combination thereof may be used. In the description herein the terms “algae” or “algal” include algae, cyanobacteria, or combinations thereof. In embodiments, algae that produces high lipid amounts may be preferred. In many embodiments, algae produced on waste water may be used. The algae may be lyophilized, dried, in a slurry, or in a paste (with for example 10-15% solid content).

After identification of a feedstock source or sources, the algae may be formed into a slurry, for example, by adding water, adding dried or lyophilized algae, or by partially drying, so that it has a solid content of from about 1-40%, such as about 4-25%, about 5-15%, about 7-12%, or about 10%.

The various steps to the process, according to some embodiments, is described in more detail below. The methods described herein may be accomplished in batch processes or continuous processes.

(1) Acid Hydrolysis

To degrade the algal cells (or other cells present), to bring cellular components into solution, and to break down complex lipids to free fatty acids, the slurry of water and algae described above may be optionally heated and hydrolyzed with at least one acidic hydrolyzing agent. These complex lipids may include, for example, triacylglycerols (TAGs), glycolipids, etc. In addition to degrading algal cells and complex lipids, the acidic environment created by addition of the hydrolyzing agent removes the magnesium from the chlorophyll molecules (magnesium can otherwise be an undesirable contaminant in some end-products, such as biodiesel).

When heated, the slurry may reach temperatures of from about 1-200° C., such as about 20-100° C., about 50-95° C., or about 90° C. When temperatures above 100° C., or the boiling point of the solution, are used, an apparatus capable of withstanding pressures above atmospheric pressure may be employed. In some embodiments, depending on the type of algae, the type and concentration of acid used for hydrolysis, the outside temperature conditions, the permissible reaction time, and the conditions of the slurry, heating may be omitted. Heating may occur prior to, during, or after addition of a hydrolyzing agent.

In addition, the slurry may be optionally mixed either continuously or intermittently. Alternatively, a hydrolysis reaction vessel may be configured to mix the slurry by convection as the mixture is heated.

Acid hydrolysis may be permitted to take place for a suitable period of time depending on the temperature of the slurry and the concentration of the hydrolyzing agent. For example, the reaction may take place for up to 72 hours, such as from about 12-24 hours. If the slurry is heated, then hydrolysis may occur at a faster rate, such as from about 15-120 minutes, 30-90 minutes, or about 30 minutes.

Hydrolysis of the algal cells may be achieved by adding to the slurry a hydrolyzing agent, such as an acid. Any suitable hydrolyzing agent, or combination of agents, capable of lysing the cells and breaking down complex lipids may be used. Exemplary hydrolyzing acids may include strong acids, mineral acids, or organic acids, such as sulfuric, hydrochloric, phosphoric, or nitric acid. These acids are all capable of accomplishing the goals stated above. When using an acid, the pH of the slurry should be less than 7, such as from about 1-6, about 1.5-4, or about 2-2.5.

In addition to strong acids this digestion may also be accomplished using enzymes alone or in combination with acids that can break down plant material. However, any such enzymes or enzyme/acid combinations would also be capable of breaking down the complex lipids to free fatty acids.

In some embodiments, the acid or enzymes, or a combination thereof, may be mixed with water to form a hydrolyzing solution. However, in other embodiments, the hydrolyzing agent may be directly added to the slurry.

(2) Base Hydrolysis

After the initial acid hydrolysis, a secondary base hydrolysis may be performed to digest and break down any remaining whole algae cells; hydrolyze any remaining complex lipids and bring those lipids into solution; convert all free fatty acids to their salt form, or soaps by saponification; and convert the chlorophyll present into a water soluble form.

In this secondary hydrolysis, the biomass in the slurry is mixed with a basic hydrolyzing agent to yield a pH of greater than 7, such as from about 8-14, about 11-13, or about 12-12.5. Any suitable base may be used to increase the pH, for example, sodium hydroxide, or other strong base, such as potassium hydroxide may be used. Temperature, time, and pH may be varied to achieve more efficient digestion.

This basic slurry may be optionally heated. When heated, the slurry may reach temperatures of from about 1-200° C., such as from about 20-100° C., about 50-95° C., or about 90° C. When temperatures above 100° C., or the boiling point of the solution are used, an apparatus capable of withstanding pressures above atmospheric pressure may be employed. In some embodiments, depending on the type of algae, the type and concentration of acid used for hydrolysis, the outside temperature conditions, the permissible reaction time, and the conditions of the slurry, heating may be omitted. Heating may occur prior to, during, or after addition of a hydrolyzing agent.

In addition, the basic slurry may be optionally mixed either continuously or intermittently. Alternatively, a hydrolysis reaction vessel may be configured to mix the slurry by convection as the mixture is heated.

Basic hydrolysis may be permitted to take place for a suitable period of time depending on the temperature of the slurry and the concentration of the hydrolyzing agent. For example, the reaction may take place for up to 72 hours, such as from about 12-24 hours. If the slurry is heated, then hydrolysis may occur at a faster rate, such as from about 15-120 minutes, 30-90 minutes, or about 30 minutes.

(3) Biomass and Liquid Phase Separation

Under the condition of elevated pH, the residual biomass may be separated from the mixed slurry. This separation is performed while the pH remains high to keep the lipids in their soap form so that they are more soluble in water, thereby remaining in the water, or liquid, phase. Once the separation is complete, the liquid phase is kept separate and the remaining biomass may be optionally washed with water to help remove any residual algal lipids, present as soap molecules. This wash water may also be collected along with the original liquid phase. Once the biomass is washed and separated it may be removed from the process as digested or residual biomass.

The liquid phase contains the recovered lipids in soap form, solubilized chlorophyll, and any other soluble cellular components. Much of the hydrophobic cellular components are potentially removed with the biomass.

Any suitable separation technique may be used to separate the liquid phase from the biomass. For example, centrifugation, gravity sedimentation, filtration, or any other form of solid/liquid separation may be employed.

(4) Precipitate Formation

After the biomass is removed, the pH of the collected liquid may be neutralized/reduced to form a solid precipitate. This may be accomplished by the addition of an acid to the solution capable of lowering the pH of the solution, such as at least one strong acid or mineral acid, for example, sulfuric, hydrochloric, phosphoric, or nitric acid. Addition of a suitable acid is performed until a green precipitate is formed. The green precipitate may contain, or may be, chlorophyll molecules that are made insoluble due to the reduced pH. The solid phase may also consist of algal proteins and other cellular components no longer soluble in water at low pH.

The pH may be reduced to a pH of about 7 or less, such as from about 3-6.9. This lower pH also converts the soap in the liquid phase to free fatty acids. As the precipitate forms the fatty acids associate with the solid phase and are precipitated with the formed solids. This is due to the hydrophobic nature of free fatty acids. Once the precipitate has formed, the solid and liquid phases may be separated. Any suitable separation method may be employed, such as centrifugation, gravity sedimentation, filtration, or any other form of solid/liquid separation. The resulting liquid phase may then be removed from the process as an aqueous phase. The collected precipitate, or solid phase, may then be processed further. Optionally, the precipitate may be lyophilized or dried, prior to the separation of the free fatty acids from the solid phase. This separation may also be conducted using wet precipitated solids.

(5) Free Fatty Extraction and Solvent Recycle

To extract or separate, the free fatty acids from the solid phase, an organic solvent may be added to the solid phase resulting from the previous step. The solid phase may be mixed with the solvent and then optionally heated to facilitate fatty acid extraction from the solid phase.

When heated, the mixture of solid phase and solvent may reach temperatures of from about 1-200° C., such as from about 20-100° C., about 50-9° C., or about 90° C. When temperatures above 100° C., or the boiling point of the mixture or slurry are used, an apparatus capable of withstanding pressures above atmospheric pressure may be employed. In some embodiments, heating may be omitted. Heating may occur prior to, during, or after the mixture of solid phase and solvent is formed. In addition, the mixture may be optionally mixed either continuously or intermittently.

The extraction process may be permitted to take place for a suitable period of time to separate the maximum amount of free fatty acids from the solid phase. For example, the extraction may take place for up to 72 hours, such as from about 12-24 hours. If the mixture is heated, then extraction may occur at a faster rate, such as from about 15-120 minutes, 30-90 minutes, or about 30 minutes.

During this time the free fatty acids associated with the solid phase are extracted or separated into the organic phase. Suitable solvents include non-polar solvents, such as hexane, chloroform, pentane, tetrahydrofuran, and mixtures thereof (for example a 1:1:1 ratio of chloroform, tetrahydrofuran, and hexane). Other suitable solid-liquid extraction methods and unit operations may be used.

Once the free fatty acids are separated into the solvent phase, the solid phase may be removed from the process and the solvent may be vaporized and recycled. What remains after the solvent is vaporized is a residue consisting of mostly the free fatty acids or algal lipids/oil. This algal oil may then optionally be processed into biodiesel.

(6) Biodiesel Production from Algal Oil and Collection

The algal oil collected in the previous step may be converted to biodiesel by esterification. This is done by the addition of a strong acid catalyst and an alcohol to the oil. With the addition of heat, the alcohol and catalyst will work to convert the free fatty acids to alkyl esters, also known as biodiesel. Generally this may be done using sulfuric acid and methanol, resulting in fatty acid methyl esters (“FAMEs”). Once the FAMEs are generated via the esterification reaction, they may be extracted from the reaction mixture using an organic solvent, such as hexane. The hexane phase containing the FAMEs is considered crude biodiesel. Further purification of the crude biodiesel may provide useable biodiesel. In addition to this method of conversion there are a number of methods that can also be used. However, this method has shown the most promise in terms of being cost effective in conversion of lipids to biodiesel.

In some embodiments, the steps outlined above may be further simplified and/or combined. For example, in some embodiments, the algal cells may be lysed by any suitable method, including, but not limited to acid hydrolysis. Other methods may include mechanical lysing, such as smashing, shearing, crushing, and grinding; sonication, freezing and thawing, heating, the addition of enzymes or chemically lysing agents. After an initial lysing of the algal cells, the pH is raised as described above in base hydrolysis to saponify the lipids present and form salts of the free fatty acids or soap molecules. After separating the residual biomass, the resulting liquid phase, which includes the salts of the free fatty acids is collected, and then a solid precipitate phase is formed with the free fatty acids associating with the solid phase by lowering the pH as described above in precipitate formation. The lipids may then be extracted or separated from the solid precipitate by a suitable method, such as those described above.

The following examples are illustrative only and are not intended to limit the disclosure in any way.

### EXAMPLES

### Example 1

### Acid Hydrolysis

To a glass test tubes 100 mg of lyophilized algal biomass was added. Wet algal biomass containing an equivalent amount of algae may also be used in this procedure. One mL of a 1 Molar sulfuric acid solution was added to the test tubes and the test tubes were then sealed using PTFE lined screw caps and gently mixed to create a homogenous slurry. This slurry was then placed in a Hach DRB-200 heat block pre-heated to 90° C. The mixture was allowed to digest for 30 minutes with mixing at the 15 minute mark.

### Example 2

### Base Hydrolysis

Once the first 30 minute digestion period of Example 1 was complete, the test tubes were removed from the heat source and 0.75 mL of a 5 Molar Sodium Hydroxide solution was added to each test tube. The test tubes were immediately resealed and returned to the heat source for 30 minutes. Mixing at 15 minutes was again provided.

### Example 3

### Biomass Removal

Once the base hydrolysis step of Example 2 was complete, the test tubes were removed from the heat source and allowed to cool in a cold water bath. Once cooled the test slurry was centrifuged using a Fisher Scientific Centrific Model 228 centrifuge to pellet the residual digested biomass. The upper liquid phases, or supernatants, were removed and collected in a separate test tubes for each sample. To the remaining biomass 1 mL of deionized water was added and vigorously mixed. The slurry was re-centrifuged, and the resulting supernatant phases were collected and added to the corresponding test tubes containing the previously collected liquid phase for each sample. The residual biomass was then removed from the process.

### Example 4

### Precipitate Formation

To the collected liquid phase of Example 3, 3 mL of a 0.5 Molar sulfuric Acid Solution was added, or until a green solid precipitate was formed. This mixture was centrifuged and the upper aqueous phase was removed from the process and the pelleted precipitated solids were further processed.

### Example 5

### Free Fatty Acid Extraction

Five mL of hexanes was added to the test tubes containing the collected precipitate of Example 4, which were sealed using a PTFE lined screw caps, and vigorously mixed. The test tubes were then placed in the Hach DRB-200 heat block set to 90° C. Extraction of the free fatty acids into the hexane phase was allowed to continue at 90° C. with vigorous mixing provided every five minutes. After a time duration of 15 minutes at 90° C. was completed, the test tubes were centrifuged to pellet the solids and to allow for the collection of the solvent phase from each sample in separate test tubes. The collected solvent phase was subjected to gentle heating under a filtered air stream to allow for the vaporization of the hexanes. The remaining residual material within each test tube consisted of mainly algal lipids as free fatty acids.

### Example 6

### Fatty Acid Esterification to Biodiesel

To the residue of Example 5, 1 mL of a 5% (v/v) solution of sulfuric acid in methanol was added. These test tubes were sealed using PTFE lined screw caps and the test tubes were heated to 90° C. for 30 minutes in a Hach DRB-200 heat block. After 30 minutes the test tubes were allowed to cool. Upon cooling 5 mL of hexanes was added to the reaction mixture and the test tubes were re-sealed and heated again for 15 minutes at 90° C. with mixing provided every five minutes. This allowed for FAMEs to be extracted into the hexane phase. The hexane phase, or crude biodiesel, was collected and analyzed for quantification of biodiesel content using gas chromatography, or other measurements were performed to analyze the crude biodiesel.

### Example 7

### Growth and Collection of Algal Biomass

Algal biomass was grown in well-mixed indoor 15 L bioreactors. The initial inoculum for each of the bioreactors originated from the Logan Lagoons municipal wastewater treatment plant located in Logan, Utah. The media in the three bioreactors were mixed using air filtered through Whatman Polyvent 0.2 um filters via spargers, pH was monitored using Sensorex pH probes and maintained at 7.7 with CO₂ addition and measured using Omega PHCN-201 pH controllers, and lighting was provided by GE Plant and Aquarium Ecolux lights with a total light intensity of approximately 1250 μmol m² s⁻¹ for a period of 14 hours per day.

Media used for the biomass was a modified form of the SE media, which contained the following macronutrients in units of g/L: 0.85NaNO₃, 0.35KH₂PO₄, 0.15MgSO₄.7H₂O, 0.15K₂HPO₄, 0.05CaCl₂.2H₂O, 0.05NaCl, and 0.015C₆H₈O₇.Fe.NH₃. Li Y, Horsman M, Wang B, Wu N, Lan CQ. Effects of nitrogen sources on cell growth and lipid accumulation of green alga Neochloris oleoabundans. Appl. Microbiol. Biotechnol. 2008; 81(4):629-636. In addition, the following micronutrients were added in units of mg/L: 2.86H₃BO₃, 1.81 MnCl₂.4H₂O, 0.22 ZnSO₄.7H₂O, 0.079 CuSO₄.5H₂O, and 0.039 (NH₄)₆Mo₇O₂₄.4H₂O. Before inoculation, the media was adjusted to a pH of 7.0 using NaHCO₃.

All biomass was harvested from the media by centrifugation. Once harvested, the algal biomass was thoroughly mixed to account for any variation in the biomass between the three reactors. Algal paste was massed into individual containers and stored at −80° C. until they were to be used or processed.

### Example 8

### Production Efficiency of Water-Based Lipid Extraction

To test efficiency and the efficacy of the procedures described herein, the outputs of biodiesel produced according to the methods described herein were tested and compared with a control. Samples were prepared according to the processes described above in Example 1-7, with the exception of the control samples.

The findings are summarized in the data tables set forth below.

TABLE 1
Results using algal biomass grown according to the
procedures in Example 7 in 15 L bioreactors using a defined media and
controlled conditions. Biomass contained 83.8% moisture by mass.
Data presented in Table 1 is the average of six replicates.

| | mg | Standard | % of |
|---|---|---|---|
| | FAME: | Deviation: (mg) | Maximum: |
| FAMEs from in-situ TE: | 11.12 | 0.26 | 100% |
| Total FAME Collected: | 10.90 | 0.35 | 98.0% |
| FAME in Hexane Phase: | 6.60 | 0.85 | 59.3% |
| FAME in precipitate: | 1.89 | 0.59 | 17.0% |
| FAME in aqueous phase: | 0.13 | 0.00 | 1.1% |
| FAME in residual | 2.29 | 0.08 | 20.6% |
| biomass: | | | |

TABLE 2
Results using biofilm based algal biomass derived from
municipal wastewater using a rotating algal biofilm reactor
apparatus. Biomass contained 89.8% moisture by mass. Data
presented within Table 2 is the average of six replicates.

| | mg | Standard | % of |
|---|---|---|---|
| | FAME: | Deviation: (mg) | Maximum : |
| FAMEs from in-situ TE: | 13.48 | 0.33 | 100% |
| Total FAME Collected: | 13.46 | 1.03 | 99.8% |
| FAME in Hexane Phase: | 7.64 | 0.48 | 56.6% |
| FAME in precipitate: | 1.00 | 0.17 | 7.4% |
| FAME in aqueous phase: | 0.31 | 0.03 | 2.3% |
| FAME in residual | 4.51 | 0.70 | 33.5% |
| biomass: | | | |

FAME production was quantified using gas chromatography. An Agilent 7890-A GC system equipped with a FID detector was used. A Restek Stabilwax-DA column (30 m×0.32 mm id×0.25 μm film thickness) was used to separate individual FAME compounds. Helium was used as the carrier gas at a constant flow rate of 2 mL/min. The oven temperature was held at 100° C. for 1 minute then increased at a rate of 10° C./min to 235° C. and held for 10 minutes. Front inlet conditions were set as follows: operated in splitless mode, initial temperature of 100° C. for 0.1 minutes then increased to 235° C. at 720° C./min. The FID was maintained at a constant temperature of 240° C. FAME concentrations were determined by comparing sample peak areas to peak areas generated by known concentration of FAMEs. Serial dilution of a C8-C24 standard mixture of FAMEs provided linear calibrations curves for quantification of individual FAMEs.

“In-Situ TE” refers to a method of transesterification (in-situ transesterification) by which dried, freeze dried in this case, algal biomass is directly contacted and subjected to, in this case, sulfuric acid, methanol, and heat. This process simultaneously extracts and converts lipids present in the algal biomass to FAMEs or biodiesel. In-situ Transesterification is the method favored, throughout the literature, to measure the biodiesel potential for various types of biomass. In situ transesterification is assumed to completely convert all present lipids in dried algal biomass to FAMEs. A subset of each batch of harvested algae was lyophilized and processed using the in situ transesterification method and the generated FAMEs quantified by GC. This served to provide a maximum biodiesel yield obtainable from the algal biomass being used, either from the bioreactor derived or the rotating algal biofilm derived algal biomass. Values obtained are presented in Tables 1 and 2 as “FAMEs from In Situ TE” based on an average of six repetitions.

To analyze the efficiency of the wet lipid extraction method a mass balance on lipids was conducted by collecting all material or streams leaving the process (residual biomass, aqueous phase, precipitated solids, and collected free fatty acid residue as shown in FIG. 1) and converting the lipids contained in that material by in situ transesterification after lyophilization of those streams containing water. This provided a means to account for the movement of lipids through the wet lipid extraction process based on the maximum biodiesel potential of the algal biomass being used as previously determined. The mass of FAMEs generated from each stream is presented in Tables 1 and 2.

“Total FAME collected” refers to the sum of FAMEs measured from each stream or intermediate step throughout the process described in this disclosure. This sum is based on averages of six 100 mg, or 100 mg equivalent, algae samples from each batch of algal biomass, bioreactor and wastewater (rotating algal biofilm reactor) derived.

“FAME in Hexane Phase” refers to the quantity of FAME generated from the residue remaining after vaporization of the hexane phase. This provides a measure of the amount of free fatty acids separated from the precipitated solid phase.

“FAME in precipitate” refers to the quantity of transesterifiable/esterifiable lipids remaining in the precipitated solid phase, formed in the base neutralization step, remaining after being extracted using the organic solvent and heat.

“FAME in aqueous phase” refers to the quantity of transesterifiable/esterifiable lipids remaining in the aqueous phase after separating the precipitated solid phase from the liquid, or aqueous, phase.

“FAME in residual biomass” refers to the quantity of transesterifiable/esterifiable lipids remaining in the residual biomass after both hydrolysis steps, water wash, and separation from the liquid phase.

### Example 9

### Pigment Precipitation

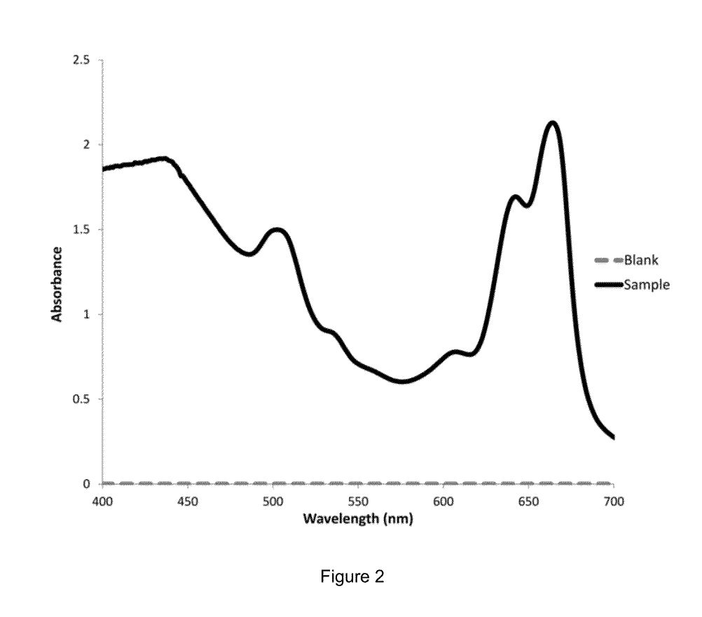

The process outlined in Examples 1-4 was performed on a sample. The resulting precipitate was freeze dried and then re-dissolved in 5 M sodium hydroxide. The resulting solution was analyzed using a Shimadzu UV-1800 UV Spectrophotometer set to measures the absorbance properties of the solution from 300 nm to 900 nm. The results are shown in FIG. 2. The “blank,” or lower line along the bottom, refers to a solution of 5 M Sodium Hydroxide; and “sample” refers to the re-dissolved precipitate solution. The data obtained from this analysis demonstrate that pigments are precipitating as a solid phase, a desirable property since pigments can be an undesirable impurity in biodiesel. This is based on the strong absorbance peaks at ranges of wavelengths similar to the absorbance pattern of chlorophyll at the specified wavelengths.

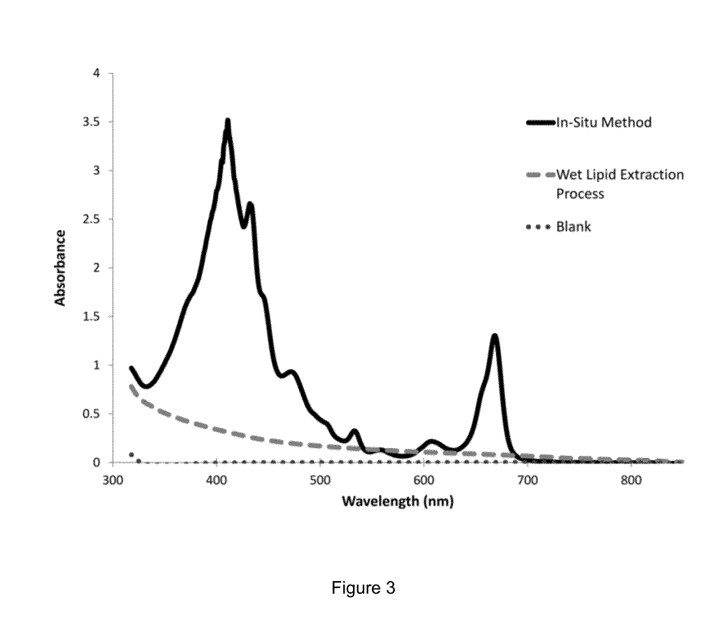

Analysis of crude biodiesel generated using the in situ transesterification method as well as the wet lipid extraction procedure described were analyzed using a Shimadzu UV-1800 spectrophotometer between the wavelengths of 300 to 900 nm. For both procedures wet algal biomass grown in bioreactors containing 83.8% moisture by mass was used. The crude biodiesel generated using the in situ transesterification procedure required a 1:10 dilution, due to the large absorbance values generated from the analysis. However, the crude biodiesel generated from the wet lipid extraction procedure did not require any dilution. FIG. 3 illustrates strong absorbance peaks typical of Chlorophyll when analyzing crude biodiesel generated using the in situ method. Crude biodiesel generated from the wet lipid extraction procedure showed significant reduction or removal of those peaks, indicating a reduction or removal of chlorophyll contamination as a result of precipitation of the chlorophyll. The data obtained from this analysis additionally demonstrate that pigments are precipitating, a desirable property since pigments can be an undesirable impurity in biodiesel.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of extracting lipids from wet algae, the method comprising:
hydrolyzing a slurry comprising algae and water by adding an acidic hydrolyzing agent to yield an acidic slurry,
hydrolyzing the acidic slurry by adding a basic hydrolyzing agent to yield a basic slurry,
separating a liquid phase from biomass in the basic slurry,
forming a precipitate within the liquid phase, and
extracting free fatty acids from the precipitate.

2. The method of claim 1, wherein the slurry has a solid content of about 4-25%.

3. The method of claim 1, wherein the acidic hydrolyzing agent is selected from the group consisting of a strong acid, a mineral acid, sulfuric acid, hydrochloric acid, phosphoric acid, and nitric acid.

4. The method of claim 1, wherein the acidic slurry has a pH of from about 1.5-4.

5. The method of claim 1, wherein the acidic hydrolyzing agent degrades the algae and breaks down complex lipids to free fatty acids.

6. The method of claim 1, wherein the acidic hydrolyzing agent removes magnesium from algal chlorophyll molecules.

7. The method of claim 1, wherein the acidic slurry is heated to a temperature of from about 50-95° C.

8. The method of claim 1, wherein the basic hydrolyzing agent is selected from the group consisting of a strong base, sodium hydroxide, and potassium hydroxide.

9. The method of claim 1, wherein the basic slurry has a pH of from about 8-14.

10. The method of claim 1, wherein the basic hydrolyzing agent converts free fatty acids from the algae to their salt form, or soap.

11. The method of claim 1, wherein the basic slurry is heated to a temperature of from about 50-95° C.

12. The method of claim 1, wherein separating the liquid phase from the biomass in the basic slurry comprises washing separated biomass.

13. The method of claim 1, wherein forming the precipitate in the liquid phase comprises lowering the pH to about 4-6.9.

14. The method of claim 1, wherein separating the free fatty acids from the precipitate comprises:
removing a solid phase containing free fatty acids that results from lowering the pH of the liquid phase; and
mixing the solid phase with a solvent to separate the free fatty acids from the solid phase.

15. The method of claim 14, wherein the solvent is selected from the group consisting of non-polar solvents, hexane, chloroform, pentane, and tetrahydrofuran.

16. A method of producing biodiesel from algae, the method comprising:
hydrolyzing a slurry comprising algae and water by adding an acidic hydrolyzing agent to yield an acidic slurry,
hydrolyzing the acidic slurry by adding a basic hydrolyzing agent to yield a basic slurry,
separating a liquid phase from biomass in the basic slurry,
forming a precipitate within the liquid phase, and
separating free fatty acids from the precipitate, and
converting the extracted free fatty acids to biodiesel by esterification.

17. A method of extracting lipids from algae, the method comprising:
lysing algal cells to form free fatty acids in an aqueous solution;
transforming the free fatty acids to soap in the aqueous solution by increasing the pH;
precipitating the free fatty acids out of the liquid phase with additional solids; and
separating the precipitated fatty acids from the precipitated solid phase.

18. The method of claim 17, further comprising converting the extracted free fatty acids to biodiesel by esterification.
